(19) United States
(12) Patent Application Publication
(10) Pub. No.: US 2005/0128350 A1
(43) Pub. Date: Jun. 16, 2005

(54) Display apparatus displaying caption information and a method thereof

(76) Inventor: Kwang-won Kim, Seoul (KR)

Correspondence Address: STANZIONE & KIM, LLP, 1740 N STREET, N.W., FIRST FLOOR, WASHINGTON, DC, 20036, US

(21) Appl. No.: 10/833,122

(22) Filed: Apr. 28, 2004

(30) Foreign Application Priority Data
Dec. 10, 2003 (KR) 2003-89457

(51) Int. Cl. H04N 5/445; H04N 7/00

(52) U.S. Cl. 348/468; 348/465; 348/569

(57) ABSTRACT

A display apparatus to receive a source signal encoded together with a plurality of caption information, and method thereof. The display apparatus includes a display displaying the caption information; a decoder decoding the plurality of caption information contained in the source signal; a caption information selection part employed in selecting at least one active caption information to be displayed among the plurality of caption information; and a multiplexing part transmitting data about the selected active caption information among the plurality of caption information decoded by the decoder to the display. With this configuration, the present invention provides the ability to selectively superimpose one or a plurality of caption information on one picture simultaneously.

### CROSS-REFERENCE TO RELATED APPLICATIONS

This application claims the benefit of Korean Patent Application No. 2003-89457, filed Dec. 10, 2003, in the Korean Intellectual Property Office, the disclosure of which is incorporated herein by reference.

### BACKGROUND OF THE INVENTION

1. Field of the Invention

The present invention relates to a display apparatus.

2. Description of the Related Art

A display apparatus receives a video signal including caption information from a television (TV) broadcasting station, a video storage medium, etc. A caption information providing system is divided into an open caption system and a closed caption system according to whether a user can select the caption information to be displayed.

In the closed caption system, a plurality of caption information is included in the video signal, and a user is allowed to select one among the plurality of caption information to be displayed. For example, the caption information about various foreign languages is included in the video signal for a movie, language study, etc., and a user can select the caption information about one among the plurality of foreign languages to be displayed.

On the other hand, if the plurality of caption information is simultaneously displayed, it may be useful for a user. For example, in the case of a picture related to the language study, if a foreign language caption is displayed together with a native language caption, it may be useful for a student. Besides, in the case of the movie in various foreign languages, the simultaneously displayed plural caption information is very useful.

However, in the conventional display apparatus displays, a user is allowed to select only one among the plurality of caption information to be displayed. Further, the conventional display apparatus is inconvenient for a user because a user has to find an active caption information service by selecting and displaying the caption information one by one.

### SUMMARY OF THE INVENTION

Accordingly, it is an aspect of the present invention to provide a display apparatus which can simultaneously superimpose one or a plurality of caption information on one picture.

Additional aspects and/or advantages of the invention will be set forth in part in the description which follows and, in part, will be obvious from the description, or may be learned by practice of the invention.

The foregoing and/or other aspects of the present invention are achieved by providing a display apparatus receiving a source signal encoded together with a plurality of caption information, comprising: a display displaying the caption information; a decoder decoding the plurality of caption information contained in the source signal; a caption information selection part employed in selecting at least one active caption information to be displayed among the plurality of caption information; and a multiplexing part transmitting data about the selected active caption information among the plurality of caption information decoded by the decoder to the display.

According to an aspect of the invention, the display apparatus further comprises a caption location selection part employed in selecting where the selected active caption information to be displayed on the display will be located, wherein the multiplexing part transmits data about a caption location selection to the display, and the display displays the active caption information thereon depending on the caption location selection.

According to an aspect of the invention, the caption information selection part comprises a menu displaying part to transmit data about the selectable caption information to the display so as to display the data, a user input part to input a selection signal for at least one active caption information, and a memory to store the data about the active caption information.

According to an aspect of the invention, the multiplexing part transmits data about at least one active caption information selected in the caption information selection part to the decoder, and the decoder decodes the active caption information.

The foregoing and/or other aspects of the present invention are also achieved by providing a display apparatus to display a plurality of caption information comprising: a display to display at least one of the plurality of caption information; a caption information selection unit to select at least one of the plurality of caption information and transmit the at least one selected caption information to the display unit.

The foregoing and/or other aspects of the present invention are also achieved by providing a method of displaying a plurality of caption information, the method comprising: selecting at least one of a plurality of caption information received together with a source signal; transmitting the selected at least one of a plurality of caption information; and displaying the transmitted at least one of the plurality of caption information

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a schematic block diagram of a display apparatus according to an embodiment of the present invention;

FIG. 2 is a schematic block diagram of a display apparatus according to another embodiment of the present invention; and

FIG. 3 illustrates a caption service menu to select active caption information and a caption location.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

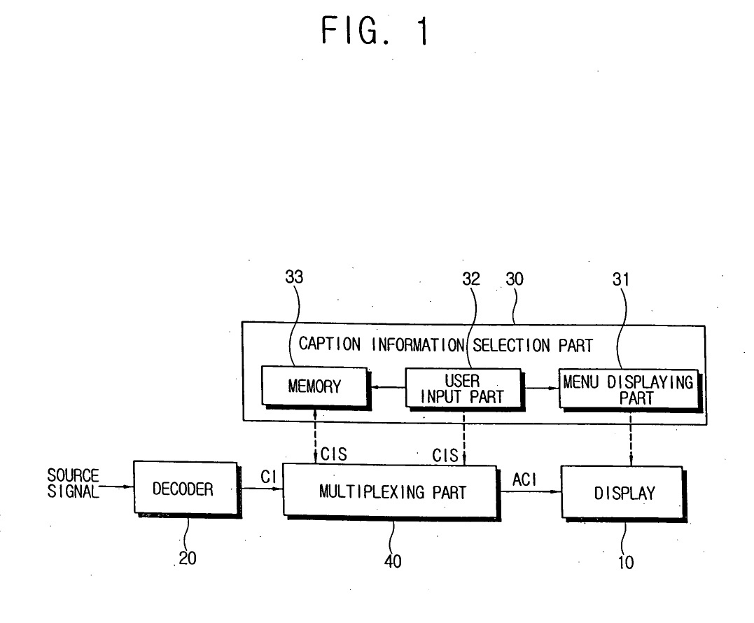

FIG. 1 is a schematic block diagram of a display apparatus according to an embodiment of the present invention.

As shown in FIG. 1, the display apparatus receives a source signal and comprises a display 10, a decoder 20, a caption information selection part 30, and a multiplexing part 40.

The source signal contains video information encoded together with a plurality of caption information. The source signal includes airwaves or a signal transmitted from a video storage medium such as a videocassette recorder (VCR), a digital video disc (DVD), a laser disc (LD), etc. In the case of the airwaves, the caption information according to a closed caption system is contained in a vertical blanking section of the source signal.

The display 10 displays the video information and the caption information contained in the source signal thereon.

The decoder 20 decodes the plurality of caption information contained in the source signal. The decoder 20 includes a microcomputer or a moving picture experts group (MPEG) decoding chip having a built-in microcomputer according to whether the source signal is an analog signal or an MPEG compressed digital signal. The respective caption information decoded by the decoder 20 is transmitted to the multiplexing part 40.

The caption information selection part 30 is employed in selecting at least one active caption information to be displayed among the plurality of decoded caption information. The caption information selection (CIS) about the selected active caption information is transmitted to the multiplexing part 40. The caption information selection part 30 can be realized by a menu displaying part 31, a user input part 32, and a memory 33.

The menu displaying part 31 transmits data about the selectable caption information to the display 10 and displays it on the display 10. The menu displaying part 31 displays, on the display 10, selection data about the caption information by a table, thereby allowing a user to easily select the caption information. The user input part 32 is employed to allow a user to input a selection signal, and comprises at least one of an on screen display (OSD) button, a remote controller, a mouse, a keyboard, etc. The memory 33 stores the selection data about the selected active caption information.

The multiplexing part 40 transmits data about the active caption information (ACI) selected by a user among the plurality of caption information (CI) decoded by the decoder 20 to the display 10. The multiplexing part 40 reads the data about the caption information selection (CIS) stored in the memory 33, or receives the selection signal about the caption information selection (CIS) from the user input part 32. Such multiplexing part 40 can be realized by embedding a predetermined program in the micro-controller having a plurality of input/output (IO) ports.

Hereinbelow, operations of the display apparatus according to the embodiment of FIG. 1 will be described in more detail.

First, the source signal is being transmitted to the decoder 20, and a user selects the caption information desired by a user to be displayed through the caption information selection part 30. The multiplexing part 40 transmits only active caption information (ACI) among the plurality of caption information (CI) decoded by the decoder 20 to the display 10. At this time, a user is allowed to select the plurality of caption information selections (CIS), and the multiplexing part 40 transmits all selected active caption information (ACI) to the display 10.

Preferably, the multiplexing part 40 transmits the data about the caption information selection (CIS) about the selected active caption information from the caption information selection part 30 to the decoder 20. Further, the decoder 20 does not decode all caption information contained in the source signal, and decodes the caption information corresponding to the active caption information (ACI). Hence, a decoding process of the decoder 20 is decreased.

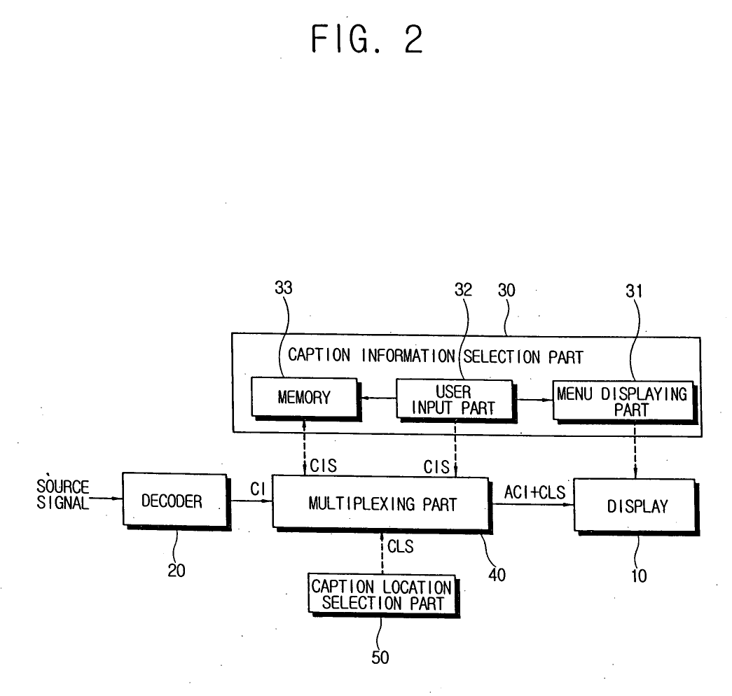

FIG. 2 is a schematic block diagram of a display apparatus according to another embodiment of the present invention.

As shown in FIG. 2, the display apparatus comprises a display 10, a decoder 20, a caption information selection part 30, a caption location selection part 50, and a multiplexing part 40. Here, the display 10, the decoder 20, the caption information selection part 30, and the multiplexing part 40 are the same as those according to the previous embodiment of FIG. 1, and therefore repetitive descriptions thereof will be omitted.

The caption location selection part 50 is employed to select where the selected active caption information by the caption information selection part 30, to be displayed on the display 10, will be located. Like the caption information selection part 30, the caption location selection part 50 comprises a menu displaying part 31, a user input part 32, and a memory 33.

The multiplexing part 40 transmits data about the decoded active caption information (ACI) and a caption location selection (CLS) selected by the caption location selection part 50 to the display 10. Then, the active caption information is displayed on the display 10 at the selected location.

Hereinbelow, operations of the display apparatus according to the present embodiment will be described in more detail.

A user selects the user input part 32 to make the menu displaying part 31 display a caption service menu on the display 10. A user selects what caption service will be provided, through the caption service menu, thereby selecting the active caption information. The data about caption information selection (CIS) is stored in the memory 33 and transmitted to the multiplexing part 40.

A user selects where the selected active caption information to be displayed on the display 10 is located, through the caption location selection part 50. Then, the caption location selection part 50 transmits data about the caption location selection (CLS) to the multiplexing part 40.

The multiplexing part 40 transmits the data about the active caption information (ACI) among the plurality of caption information decoded by the decoder 20 and the caption location selection (CLS) to the display 10. The display 10 displays the active caption information at the selected location.

In an aspect of this embodiment, the caption location selection part 50, similar to the caption information selection part 30, comprises a menu displaying part 31, a user input part 32, and a memory 33.

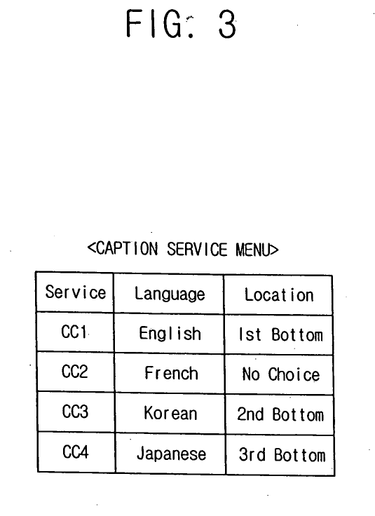

FIG. 3 illustrates a caption service menu to select active caption information and caption location.

As illustrated in FIG. 3, the caption service menu is itemized by a service, a language and a location.

A service item divides the caption information. The number of caption information serviced by the airwaves is determined according to whether the display apparatus is an analog type or a digital type display apparatus. For example, the number of possible caption services is four in the analog type display apparatus and is six in the digital type display apparatus.

The language item indicates various languages corresponding to the respective caption services CC1˜CC4. Recently, the digital TV broadcasting station provides system information (SI) including contents of the caption services CC1˜CC4. Here, the language item can vary according to the SI regardless of the caption services CC1˜CC4.

The location item is employed in selecting where the caption information will be located relatively to each other, or selecting whether the caption information will be displayed or not. The location is selected in the case of the active caption services among the caption services CC1˜CC4, but “NO CHOICE” is shown in the case of the inactive caption services. Here, the active caption services should be located such that they do not overlap each other. As a specification of the caption information, the size of a font, the number of lines, and the size of a block can vary selectively. In FIG. 3, each caption information has a hierarchical structure, but may have various structures to superimpose the caption information on a picture.

As described above, the present invention provides a display apparatus which can selectively superimpose one or a plurality of caption information on one picture simultaneously.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A display apparatus receiving a source signal encoded together with a plurality of caption information, comprising:
a display displaying the caption information;
a decoder decoding the plurality of caption information contained in the source signal;
a caption information selection part to select at least one active caption information to be displayed among the plurality of caption information; and
a multiplexing part transmitting data about the selected active caption information among the plurality of caption information decoded by the decoder to the display.

2. The display apparatus according to claim 1, further comprising a caption location selection part employed in selecting where the selected active caption information to be displayed on the display will be located,
wherein the multiplexing part transmits data about a caption location selection to the display, and the display displays the active caption information thereon depending on the caption location selection.

3. The display apparatus according to claim 1, wherein the caption information selection part comprises:
a menu displaying part to transmit data about the selectable caption information to the display to display the data;
a user input part to input a selection signal for at least one active caption information; and
a memory to store the data about the active caption information.

4. The display apparatus according to claim 1, wherein the multiplexing part transmits data about at least one active caption information selected in the caption information selection part to the decoder, and
the decoder decodes the active caption information.

5. The display apparatus according to claim 1, wherein the decoder includes a microcomputer.

6. The display apparatus according to claim 1, wherein the decoder includes a moving picture experts group (MPEG) decoding chip having a built-in microcomputer.

7. A display apparatus comprising:
a display to display at least one of a plurality of caption information;
a caption information selection unit to select at least one of the plurality of caption information and transmit the at least one selected caption information to the display unit.

8. The display apparatus according to claim 7, wherein the caption information selection unit comprises:
a caption information selection part to select the at least one of the plurality of caption information; and
a multiplexing part to transmit the selected at least one of the plurality of caption information to the display.

9. A method of displaying caption information, comprising:
selecting at least one of a plurality of caption information received together with a source signal;
transmitting the selected at least one of the plurality of caption information; and
displaying the transmitted at least one of the plurality of caption information.

10. An apparatus to display caption information in a display, comprising:
a caption information selection part to select at least one caption information; and
a multiplexing unit to generate the at least one caption information to be displayed.

11. The apparatus according to claim 10, further comprising:
a display connectable to the multiplexing unit to display the two or more caption information.

12. The apparatus according to claim 11, further comprising:
a caption location selection part to select the location of the caption information to be displayed.
